(19) United States
(12) Patent Application Publication
(10) Pub. No.: US 2007/0168075 A1
(43) Pub. Date: Jul. 19, 2007

(54) Method and installation for processing waste paper

(76) Inventors: Markus Dinkel, Eppishausen (DE); Volkmar Mickal, Erlangen (DE); Thomas Runkler, Munchen (DE); Albrecht Sieber, Mohrendorf (DE); Klaus Villforth, Seeheim-Jugenheim (DE)

Correspondence Address: BAKER BOTTS L.L.P., 30 ROCKEFELLER PLAZA, 44TH FLOOR, NEW YORK, NY, 10112-4498, US

(21) Appl. No.: 11/568,294

(22) PCT Filed: Apr. 18, 2005
(86) PCT No.: PCT/EP05/51691

§ 371 Date: Oct. 25, 2006

(30) Foreign Application Priority Data
Apr. 26, 2004 (DE) 10 2004 020 495.0

(51) Int. Cl. D21H 23/78; G06F 7/66; D21C 9/00; D21C 5/02

(52) U.S. Cl. 700/127; 162/198; 162/189; 162/263

(57) ABSTRACT

A method for the treatment of waste paper to produce a finished product in several process stages, comprises the steps of for at least one quality parameter, prescribing a set value for the finished product, wherein ahead of and/or following at least two of the process stages a value is determined by measurements of the at least one quality parameter, establishing the efficiency of a process stage with regard to the improvement of the at least one quality parameter in this process stage, and dynamically balancing in a process management system the individual process stages taking into account the overall efficiency of the process.

### CROSS-REFERENCE TO RELATED APPLICATIONS

This application is a U.S. national stage application of International Application No. PCT/EP2005/051691 filed Apr. 18, 2005, which designates the United States of America, and claims priority to German application number DE 10 2004 020 495.0 filed Apr. 26, 2004, the contents of which are hereby incorporated by reference in their entirety.

### TECHNICAL FIELD

The invention relates to a process for the treatment of waste paper to produce a finished product in several process stages, where for at least one quality parameter a set value for the finished product is prescribed, where ahead of and/or following at least two of the process stages a value is determined by measurements of the at least one quality parameter. The invention also relates to an appropriate plant for processing of the waste paper.

### BACKGROUND

In many countries waste paper is the most important raw material for the paper and the cardboard industry. In that context, within the paper industry too, both product quality requirements and the pressure on cost reduction are rising steadily. In terms of the suitability of waste paper for use as a raw material, and particularly so in the case of higher-quality printing papers, the material composition, the efficiency of the sorting operation and the degree of soiling are decisive. The processing of waste paper is detrimentally influenced by an increasing content of non-paper constituents such as adhesives, plastic films, metal clips, textiles, synthetic materials and types of paper and board which are not suitable for recycling. For example, the composition of waste paper is affected by seasonal variations in the consumption of paper, the differences between different local collection systems and the nature of the sorting activity.

Currently, routine laboratory measurements document the quality variations which occur in the conversion stages from waste paper to finished material and supply important information about the operating conditions prevailing in the processing installation. As a general rule, a waste paper processing installation operates in several stages. The routine laboratory measurements are time-consuming and in particular, therefore only of limited suitability for the control of the waste paper processing operation and its processing stages. This means that only a delayed reaction to quality changes is possible and that such delays can be relatively substantial.

DE 196 53 479 C1 describes a method for process control in the case of bleaching fibrous materials. It provides for the use of a state model and a process model to optimize a bleaching activity. According to DE 196 53 479 C1 measurements are made on a sample sheet prepared from a suspension of stock or on the suspension of stock itself and are then employed to assist in establishing the abovementioned models.

At the present time the basic problems associated with quality control during the processing of waste paper such as the mutual interdependence of the individual process stages, e.g. bleaching and flotation and substantial periods of dead time have not been resolved or at least not resolved satisfactorily.

### SUMMARY

It is the object of the invention to make available an improved method of waste paper processing such that due account is taken of, in particular, the foregoing problems and of the higher level of requirements being experienced in the paper industry and referred to at the beginning

This task is resolved by a process of the nature mentioned initially, where the efficiency of a processing stage with respect to the improvement attained within that stage is determined in terms of the at least one quality parameter and where in a process control system a dynamic matching of the individual process stages takes place taking into consideration the overall efficiency of the process.

According to the invention an overriding quality control for the processing of waste paper is provided which profits especially those waste paper processing installations where the quality of the waste paper varies. According to the invention, product- and/or customer-specific quality requirements for the finished material can be obtained at the lowest possible level of cost. According to the invention no longer are only individual process stages carried out under optimum conditions, but rather an optimal-cost matching of the individual process stages is achieved. This involves engaging the individual partial-optimizations of the process stages and the matching in a timing and optimal-cost manner of the individual process stages from the in-feed of the waste paper to the delivery of the finished material in such a manner that allowance can be made quickly and efficiently for quality variations in the waste paper.

The matching of the individual process stages results advantageously from step-wise adaptation of the process stages. In this way optimal matching of the installation is achieved by a successive approach to an optimal-cost development of the quality parameter accompanied by a relatively low expenditure.

It is of advantage if the matching of the process stages takes place by means of predictive-model control. In this way the stability of the process and the control thereof is increased.

It is advantageous if the prescription of the set values in the context of the predictive-model control procedure for one process stage is made with the aid of measurements taken ahead of this process stage. In this way allowance can be made particularly quickly for variations in the process and, in particular, those which can be attributed to a change in the quality of the waste paper.

The prescription of the set values for one process stage is preferably made with the aid of at least one model for the process stage. This ensures that the control system will respond within a very short reaction time.

Preferably the at least one model is adapted. This results in a further increase in the level of control accuracy.

It is advantageous if the efficiency of a process stage is entered into a model in the form of a cost-efficiency factor. This ensures that the cost-return ratio not only of individual process stages but rather of the overall process can be optimized by a very short reaction time when changes occur in the process.

It is expedient that the regulation of quality for a process stage is effected by a regulation module assigned to the process stage. In this way and amongst other consequences the batch processing times in the process stage are monitored in order to be able to compute the time for any required interventions to be made.

It is of advantage if the control module operates in a predictive-model manner. The optimal procedure for carrying out a process stage is recorded implicitly in such a control module based upon data and analytical information.

It is expedient to use the degree of whiteness and/or the loading content as quality parameters. The degree of whiteness is certainly the most important optical property of paper. The loading content can, for example, be definitive for the printability properties of the paper and it also has an influence upon the degree of whiteness.

It is of advantage if the determination of a value of the at least one quality parameter is performed by means of at least one softsensor. This permits the development of the quality parameter during the course of the process stages to be monitored in a particularly effective manner.

It is of advantage if the determination of a value of the at least one quality parameter is made online. In this way, values are made available particularly quickly and the reaction speed of the control system is significantly increased.

To achieve effective de-inking of waste paper it is of advantage if one or more process stages takes the form of flotation and/or bleaching activity. For example, in a waste paper processing activity a first so-called pre-flotation activity can be followed by a bleaching operation after which follows a post-flotation stage which in turn is followed by a bleaching operation.

The efficiency of a process stage involving bleaching can be of especial advantage if determined as the ratio between the improvement of the at least one quality parameter of the bleaching activity and the consumption of energy and/or of the dosing rate of chemicals in the bleaching activity. This is a particularly reliable approach for determining the effectiveness of the bleaching operation.

In addition to the dependence on general operating conditions, de-inking chemistry and/or the loss of solids in the flotation activity it is of advantage if the efficiency of a process stage involving flotation is determined in dependence upon the improvement in the at least one quality parameter in the flotation activity. This approach permits a reliable assessment to be made of the effectiveness of the flotation activity.

It is advantageous for at least one measurement point for the measurement of a value of the at least one quality parameter to be located ahead of the first process stage involving flotation. If the value of the quality parameter is first determined as soon as possible after the disintegration stage but at the latest before the first flotation stage, this value is at least approximately representative of the quality of the waste paper before being processed.

It is of advantage if a device for carrying out a process stage and exhibiting a basic automation facility is provided and has at least one regulation module assigned to the process stage which overrides the basic automation facility, which amongst other functions determines, for example, set values and monitors the processing times in the process stage.

### BRIEF DESCRIPTION OF THE DRAWINGS

In what follows below further details and advantages of the invention are clarified by embodiment examples and by reference to the drawings. These show:

FIG. 1 Process stages and selected measurement locations,

FIG. 2 an example of a development of a quality parameter in the processing of waste paper,

FIG. 3 a schematic representation of a control facility with successive approach to an optimal-cost development of the quality parameter, and

FIG. 4 a schematic representation of a control facility with predictive-model approach.

### DETAILED DESCRIPTION

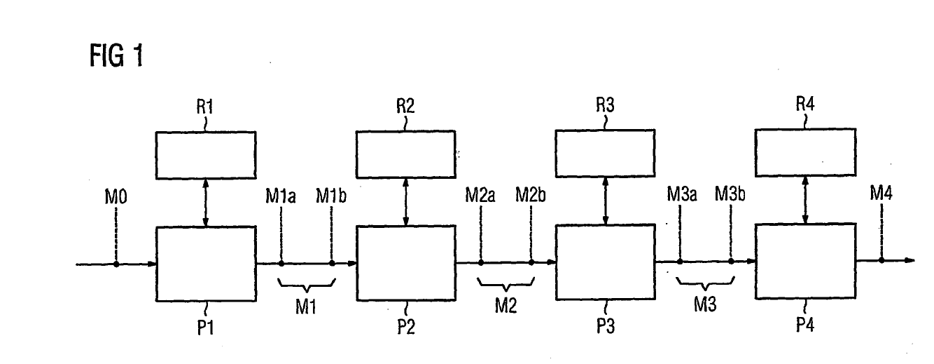

FIG. 1 shows several process stages P1 to P4 for a waste paper processing activity together with several measurement locations M0 to M4, which are arranged between the process stages P1 to P4 or before or after process stages P1 to P4. Online measurements are made at the measurement locations M0 to M4 to effect virtual real-time capture of quality parameters. The regulation modules R1 to R4 are assigned to the individual process stages P1 to P4.

In what follows it is assumed solely for the purpose of providing an example that the process stage P1 consists of pre-flotation, the process stage P2 of disperger bleaching, the process stage P3 of post-flotation, and the process stage P4 of disperger bleaching.

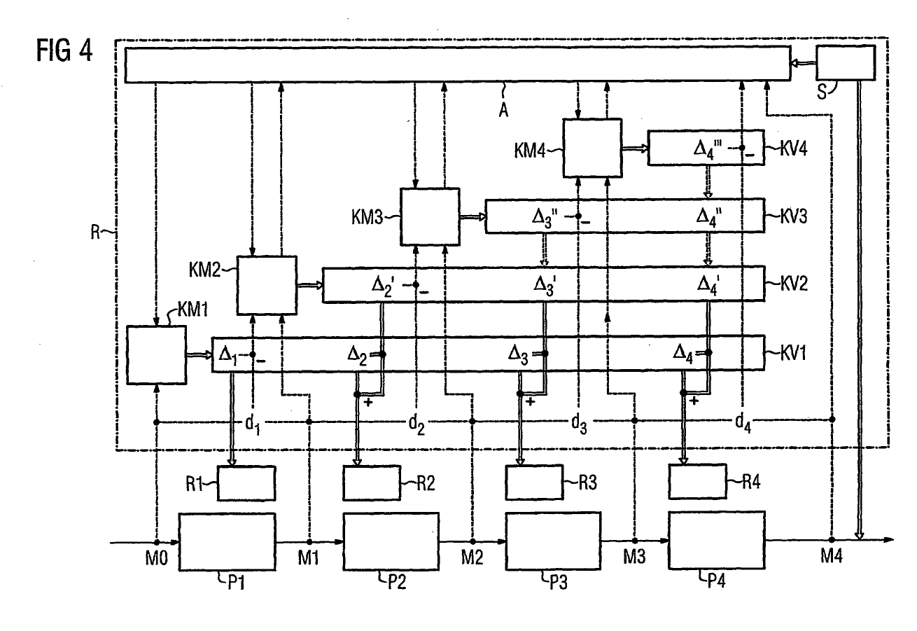

As the quality parameters QP (see also FIG. 4) the degree of whiteness, the production volume, the loading content or other paper quality-relevant properties are determined. The quality parameter QP can be determined, for example, on the waste paper, on the suspension of waste paper, on the fibrous material or on the finished material.

For example, the degree of whiteness of the fibrous material which has not yet been de-inked is determined at measurement location MO, which is preferably arranged between the coarse-sorting and pre-flotation stages. A degree of whiteness soft sensor compensates for the influencing factors of material density, fine and loading content and is able thereby to supply the degree of whiteness of a test sheet made from material which has not yet been de-inked. The measurement location M1 between the pre-flotation and disperger-bleaching stages permits still finer differentiation to be made at a measurement location M1a in the accepted stock at the pre-flotation stage and a measurement location M1b following the thickening operation. Here the degree of whiteness of a test sheet is determined with the aid of sensors. A further measurement location M2 is arranged between the process stage P2 and the process stage P3, in other words following a preferably oxidizing disperger bleaching operation and preferably in the in-feed to the post-flotation activity. Analogously to the Mla and M1b measurement locations, sensors at the measurement locations M3a and M3b or measurement location M3 acquire the degree of whiteness of the material following the flotation processing. For example, a transmitter at measurement location M4 inside the bleaching pipe measures the degree of whiteness of the de-inked finished material.

The control module R1 or R3 of a flotation stage consists preferably of a model-based feed-forward element in order to adapt the reject rate to the properties of the fibrous suspension. The optimal operating condition for the flotation activity is implicitly recorded in a flotation model supported by process data based upon data and analytical information. In the feedback element of the regulation module R1 or R3 the prediction is compared with the degree of whiteness actually achieved. This comparison post-adapts the model since not all the influencing factors are known and therefore the accuracy of the prediction is limited by the missing input data.

A particular problem of the disperger-bleaching activity as exemplified by the process stages P2 and P4 is that of the long batch processing times which depend, in particular, upon the current load experienced by the installation. This situation limits the dynamic of the feedback element so that the model-based feed-forward element of the regulation module R2 or R4 of a disperger-bleaching operation must control the process over a distinctly longer time than in the case where the flotation activity proceeds without information from the feedback element. At least to a partial extent compensation for this can be made by an independent dead-time model.

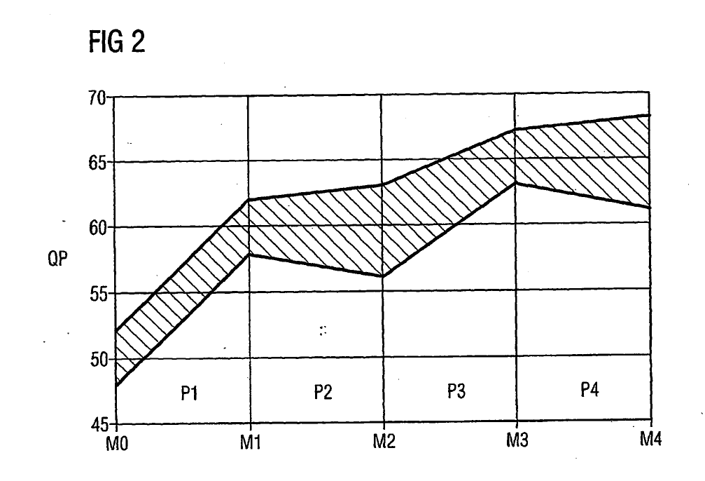

FIG. 2 illustrates an example for the development of a quality parameter QP in the processing of waste paper. A specific example is provided of a typical development pattern of a degree of whiteness in a waste paper processing installation. The degree of whiteness is certainly the most important optical property of paper and therefore constitutes a particularly important quality parameter QP. The degree of whiteness is preferably determined as the ISO-degree of whiteness in the blue region of the spectrum for wavelengths centered around 457 nm.

The degree of whiteness of the de-inked finished material is attained by removal of the printing ink and bleaching of the fibrous material. FIG. 2 shows the corridor of the development of the degree of whiteness through the process stages P1 to P4. In the example these consist therefore of pre-flotation, disperger-bleaching, post-flotation and post-disperging followed by reductive bleaching. This involves each process stage P2 to P4 contributing to the result provided by one or more of the preceding process stages P1 to P3. Thus the gray character of the fibrous material in the disperger depends upon the energy input and the associated displacement of the size distribution of the particles of printing ink. The modified spectrum of the printing ink particles and the added bleaching chemicals again influence the efficiency of the post-flotation activity. However, the bleaching stages also depend upon the fibrous material and its previous history. As is customary, the degree of whiteness is expressed as a percentage in the drawing.

The removal of the printing ink in the process stages P1 and P3, i.e. the flotation activities, is influenced above all else by the general operating conditions, the de-inking chemistry and the loss of solids. The disperger bleaching, i.e. process stages P2 and P4, where preferably the first disperger-bleaching operation (Process stage 2) involves the use of peroxide bleach and where the second disperger-bleaching operation (Process stage P4) preferably involves the use of a dithioniate bleach are particularly influenced by the level of energy input and of chemical dosing. A particularly important factor in the process of waste paper processing is the costs of the different operating conditions.

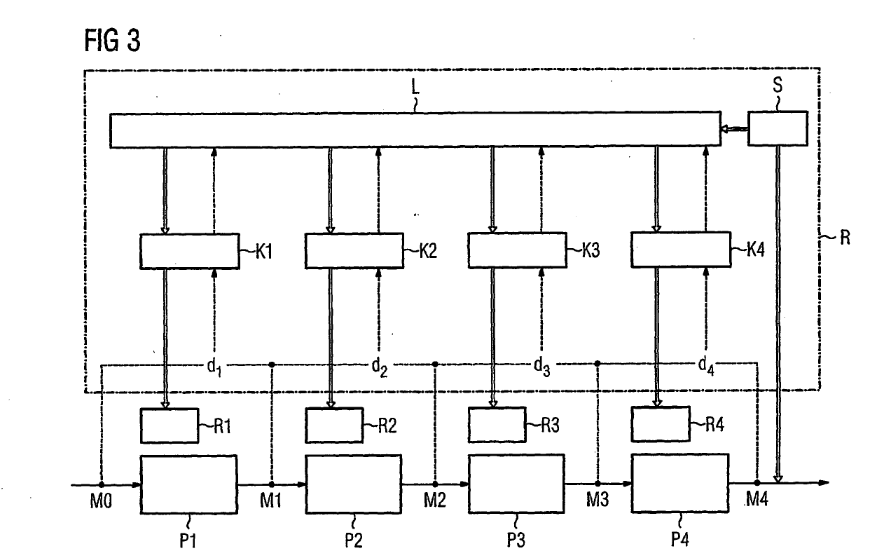

FIG. 3 displays schematically a control system with a successive approach to an optimal-cost development of the quality parameter QP, e.g. of the degree of whiteness. This involves the changes of the values of the quality parameter QP in the individual process stages P1 to P4 being determined as quality changes d₁ to d₄. In the stage efficiency modules Kl to K4 the cost-efficiency in the process stages is determined and passed on to a process efficiency module L. A unit S capable of prescribing set values provides a set value for the at least one quality parameter QP at the end of the process. This prescribed set value is also passed to the process efficiency module L. With the aid of the process efficiency module L and the stage efficiency modules K1 to K4 the pre-set values for quality changes in the individual process stages P1 to P4 are modified in a step-wise manner in the direction associated with lower costs, i.e., in particular, in the direction of lower overall costs until an optimal balance is established within the installation. This ensures that the set values prescribed by the set value unit S are observed. The control system illustrated in FIG. 3 is not dependent on a process model, since variations in the fibrous material composition and changes in the operating conditions in the installation are fed directly to the process stages P1 to P4 and their cost efficiency is recorded.

FIG. 4 displays schematically a control system with predictive-model approach. The control system relates to non-de-inked fibrous material for which a value for the quality parameter QP is determined at the measurement location MO. Next and in a first step, the most cost-favorable distribution of the quality changes d₁ to d₄, e.g. the increase in degree of whiteness, is determined over all the following process stages P1 to P4. Preferably this takes place in a set value correction module KM1. Prescribed set values Δ₁ to Δ₄ for the process stages P1 to P4 are passed from the set value correction module KM1 to a set value prescribing module KV1. To determine the most cost-efficient distribution of the quality changes d_{1 to d}₄ the cost efficiency per process stage P1 to P4 is recorded in at least one cost model.

Preferably a cost model is recorded for each process stage from P1 to P4.

In a set value correction module KM2 a new calculation is made of the most cost-favorable distribution of the quality changes d₂ to d₄ in respect of the process stages P2 to P4 which follow the process stage Pi. The results obtained from process stage Pi are included in the new calculation. In this way and on the basis of the flotation results new set values are calculated for the fibrous material which has passed through the pre-flotation stage. This includes taking account of the de-inking capability of the fibrous material and of the operating conditions in the installation within the quality control procedure. Appropriate set value corrections Δ₂′ to Δ₄′ are recorded in the set value prescribing module KV2. The set value corrections Δ₂′ to Δ₄′ are used to correct the prescribed set values Δ₂ to Δ₄.

The results obtained from process stage P2, the first disperger-bleaching activity, are available to the set value correction module KM3 in order that prescribed values for the subsequent process stages P3 to P4 can be determined. In an analogous manner, set value corrections Δ₃″ and Δ₄″ are recorded in the set value correction module KV3 and used. Finally, the results of the process stage P3 are also available to the set value correction module KM4 to permit the calculation of a set value correction Δ₄′″.

The predictive-model control system operates in a dynamic manner. The basic advantage lies in the high speed and the stability provided by the model-based feed-forward element. In this way the full potential of the fibrous material and of the process stages Pi to P4 can be realized in an optimal manner. Quality variations pass into the control system as does a changed cost situation. An adaptation module A is provided in order to post-adjust the models used to determine the pre-set values which are preferably implemented in the set value correction modules KM1 to KM4. To improve the models used and in addition to the process-generated variations of the installation in the context of trial runs, specific changes can be made to the operating conditions in order to record a comprehensive representation in the database of the models. The continuous matching of the process stages P1 to P4 with respect to one another facilitates an optimal-cost operation of the waste-paper processing operation.

The basic teaching of the invention may be summarized essentially as follows: The invention relates to a process and a plant for the treatment of waste paper to produce a finished product in several process stages, where a set value is prescribed for the degree of whiteness of the finished product and the degree of whiteness is measured between the process stages P1 to P4. According to the invention the efficiency of a processing stage is determined after taking into account the costs associated with increasing the degree of whiteness and in a process control system a dynamic matching of the individual process stages is undertaken paying due regard to the overall efficiency of the process and, in particular, the overall cost efficiency. Quality parameters such as the degree of whiteness are captured on a virtual real-time basis and evaluated. This is followed by a modeling of the pattern of quality and cost development in the individual process stages P1 to P4 accompanied by a dynamic, on-going matching of the data in the individual process stages P1 to P4. In this way the overall efficiency of the waste paper processing is significantly increased.

Previously-known processes for processing waste paper failed by a considerable margin to realize the potential of the installation and of the fibrous material because, amongst other considerations, in the previously-known processes mutual interdependencies of the process stages P1 to P4 were not quantified. According to the invention not only is a more stable operation of the installation guaranteed but also account can be taken of short-term variations in the composition of the fibrous material and the content of printing ink. According to the invention the individual process stages P1 to P4 are dynamically matched in such a manner that the over all efficiency of the process is given consideration. An important factor in that regard relates to the costs of the different operating conditions. Attention is paid to the costs of the waste paper as a raw material, the costs of chemicals, energy and disposal of the residual waste materials. The evaluation of the quality parameters takes place in dependence upon the operating conditions of the installation and the specified criteria for the end product. The individual process stages are optimally matched with respect to one another in terms of the degree of whiteness and the loading content together with effective utilization of installation capacity and the associated batch processing times. According to the invention, the matching of the process stages takes place continuously, virtually on a real-time basis and online throughout the ongoing process.

What is claimed is:

1. A method for the treatment of waste paper to produce a finished product in several process stages, the method comprising the steps of:
for at least one quality parameter, prescribing a set value for the finished product, wherein ahead of and/or following at least two of the process stages a value is determined by measurements of the at least one quality parameter,
establishing the efficiency of a process stage with regard to the improvement of the at least one quality parameter in this process stage, and
dynamically balancing in a process management system the individual process stages taking into account the overall efficiency of the process.

2. The method according to claim 1, wherein the matching of the individual process stages results from step-wise adaptation of the process stages.

3. The method according to claim 1, wherein the matching of the process stages takes place by means of predictive-model control.

4. The method according to claim 3, wherein the prescription of the set values for one process stage is made with the aid of measurements taken ahead of this process stage.

5. The method according to claim 4, wherein the prescription of the set values for one process stage is made with the aid of at least one model for the process stage.

6. The method according to claim 5, wherein the at least one model is adapted.

7. The method according to claim 1, wherein the efficiency of a process stage is entered into a model in the form of a cost-efficiency factor.

8. The method according to claim 1, wherein the regulation of quality for a process stage is effected by a regulation module assigned to the process stage.

9. The method according to claim 8, wherein the regulation module operates in a predictive-model manner.

10. The method according to claim 1, wherein the degree of whiteness is used as the quality parameter.

11. The method according to claim 1, wherein the loading content is used as the quality parameter.

12. The method according to claim 1, wherein the determination of the value of the at least one quality parameter is performed by means of at least one soft sensor.

13. The method according to claim 1, wherein the determination of the value of the at least one quality parameter is made online.

14. The method according to claim 1, wherein one or more process stages takes the form of flotation and/or bleaching activity.

15. The method according to claim 14, wherein the efficiency of the bleaching activity is determined as the ratio between the improvement of the at least one quality parameter(QP) of the bleaching activity and the consumption of energy and/or of the dosing rate of chemicals in the bleaching activity.

16. The method according to claim 14, wherein the efficiency of the flotation activity is determined in dependence upon the improvement in the at least one quality parameter in the flotation activity as well as in dependence upon the operating conditions, de-inking chemistry and/or loss of solid material.

17. The method according to claim 14, wherein at least one measurement point for the determination of a value of the at least one quality parameter is located ahead of the first process stage involving flotation.

18. A plant for the treatment of waste paper to produce a finished product in several process stages, comprising:
several items of equipment for carrying out respective process stages,
several measurement devices to determine a value of the at least one quality parameter, wherein a measurement device is installed at the entry point and the discharge point, ahead of and/or after a device for carrying out a process stage,
a set value prescribing unit to prescribe a set value for the finished product, and
a process management system for the dynamic balancing of the individual process stages taking into account the efficiency of the individual process stages and the overall efficiency of the process.

19. The plant according to claim 18, wherein a device for carrying out a process stage has a basic automation capability and at least one regulating module over-riding the basic automation activity.
